(19) United States
(12) Patent Application Publication
(10) Pub. No.: US 2025/0351870 A1
(43) Pub. Date: Nov. 20, 2025

(54) AEROSOLISATION ASSEMBLY

(71) Applicant: Philip Morris Products S.A., Neuchatel (CH)

(72) Inventor: Enrico TURRINI, Neuchatel (CH)

(73) Assignee: Philip Morris Products S.A., Neuchatel (CH)

(21) Appl. No.: 18/854,364

(22) PCT Filed: Apr. 13, 2023
(86) PCT No.: PCT/EP2023/059704

§ 371 Date: Oct. 4, 2024

(30) Foreign Application Priority Data
Apr. 14, 2022 (EP) 22168572.0

(51) Int. Cl. A24F 40/05; A24F 40/10; A24F 40/42; A24F 40/44; B05B 17/00; B05B 17/06

(52) U.S. Cl. CPC A24F 40/05; A24F 40/10; A24F 40/42; A24F 40/44; B05B 17/0646; B05B 17/0669; B05B 17/0684

(57) ABSTRACT

A vibratory aerosolisation assembly for an aerosol-generating device is provided, including: an aerosolisation component including a vibratable transducer and a membrane, the transducer being coupled to the membrane to vibrate it in an axial direction; a substantially flexible annular sealing component sealably coupled to a peripheral sealing region of the aerosolisation component; and a substantially rigid casing coupled to the sealing component, the coupling being confined to a retention region of the sealing component, the retention region disposed outward of an outermost periphery of the aerosolisation component, the casing is more rigid than the sealing component, a parameter of the sealing component militating against damping a vibratory output of the transducer during use and including one or more of: a hardness of the sealing component, a Young's modulus of the sealing component, and an axial thickness of the sealing component, the casing defining a bore circumferentially surrounding the sealing component.

The present disclosure relates to a vibratory aerosolisation assembly for use in an aerosol-generating device, as well as a method of fabricating a vibratory aerosolisation assembly. The present disclosure also relates to an aerosol-generating device including such an aerosolisation assembly.

Known vibrating nebulizers for aerosolising a liquid aerosol-forming substrate employ a membrane having a distribution of holes. The membrane is coupled to a vibratable transducer coupled to the periphery of the membrane. It is known for the transducer to be enclosed and retained within an annular sealing element. An electrical signal provided to the transducer is converted to a vibratory output by the transducer, with the vibratory output of the transducer inducing vibration of the membrane. Liquid fed to one surface of the membrane is ejected through the holes of the membrane as a distribution of aerosol droplets due to the vibratory output of the transducer. However, enclosure and retention of the annular transducer by the sealing element may dampen the vibratory output from the transducer, thereby restricting the vibratory response of the membrane. Consequently, the volume and speed of aerosol droplets emanating from the membrane may also be reduced. So, dampening of the vibratory output of the transducer reduces the quality of the aerosol droplet dispersion pattern emanating from the membrane.

The present disclosure relates to provision of a vibratory aerosolisation assembly for use with an aerosol-generating device which addresses one or more of the problems described above.

According to an aspect of the present disclosure, there is provided a vibratory aerosolisation assembly for use in an aerosol-generating device. The vibratory aerosolisation assembly comprises an aerosolisation module, a substantially flexible annular sealing member, and a substantially rigid casing. The aerosolisation module comprises a vibratable transducer and a membrane. The vibratable transducer is operably coupled to the membrane so as to, in use, vibrate the membrane in a substantially axial direction. The sealing member is sealably coupled to a peripheral sealing region of the aerosolisation module. The substantially rigid casing is coupled to the sealing member. The coupling of the casing to the sealing member is confined to a retention region of the sealing member. The retention region is located outward of an outermost periphery of the aerosolisation module. The casing is more rigid than the sealing member. At least one parameter of the sealing member may be configured so as to militate against damping a vibratory output of the vibratable transducer during use, the at least one parameter comprising one or more of: a hardness of the sealing member; a Young's modulus of the sealing member, and an axial thickness of the sealing member.

As used herein, the term “vibratable transducer” is used to refer to a device configured to convert energy from an initial form into a different form, where the different form comprises or consists of a vibratory output.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

As used herein, the term “liquid” refers to a substance provided in liquid form and encompasses substances provided in the form of a gel.

As used herein, the term “axial thickness of the sealing member” refers to the thickness of sealing member measured in a direction perpendicular to a plane generally defined by the membrane.

Militating against damping of the vibratory output of the transducer facilitates enhancing the vibratory output of the transducer for a given energy input into the transducer. In turn, this facilitates enhancing the magnitude of displacement of the vibrating membrane and thereby the quality of the aerosol droplet formation pattern generated in response to vibration of the membrane.

Ensuring that the retention region between the rigid casing and the sealing member is situated outward of an outermost periphery of the aerosolisation module also reduces dampening of the vibratory output of the transducer caused by contact between the casing and sealing member. Locating the retention region outward of the outermost periphery of the aerosolisation module allows the vibratory response of the transducer in response to a given energy input to the transducer to get closer to the idealised vibratory response of the transducer being completely unconstrained or free.

The substantially rigid casing may form all or part of a housing of an aerosol-generating device. By way of example, the substantially rigid casing may be formed from materials such as rigid plastic material (such as but not limited to polypropylene, high-density polyethylene (HDPE), polyethylene terephthalate (PET), polyetheretherketone (PEEK), or polysulfone (PSU)) or a metallic material (such as but not limited to aluminium). By having the retention region between the rigid casing and sealing member located outward of the outermost periphery of the aerosolisation module, any constraint imposed by the casing on the sealing member occurs some distance away from the aerosolization module. Consequently, any dampening of the vibratory output of the transducer of the aerosolization module resulting from the casing constraining the sealing member may be minimised. The reduced dampening may enhance the vibratory displacement of the membrane, thereby improving the quality of the aerosol droplet dispersion pattern when a liquid aerosol-forming substrate is fed to a surface of the membrane. As used herein, the term “constraint” refers to a restriction on movement of the sealing member.

The hardness, Young's modulus and axial thickness of the sealing member are all parameters whose values influence the extent to which the sealing member itself constrains movement (and thereby the vibratory output) of the transducer of the aerosolization module. A reduction in hardness of the sealing member would reduce the constraining effect of the sealing member on the transducer. Similarly, a reduction in the Young's modulus of the sealing member would also reduce the constraining effect of the sealing member on the transducer. Further, a reduction in the axial thickness of the sealing member would also reduce the constraining effect of the sealing member on the transducer. Reducing the extent to which the sealing member constrains movement of the transducer of the aerosolisation module reduces dampening of the vibratory output of the transducer by the sealing member. The net effect of a reduced constraint of the sealing member on the transducer is an increase in vibratory displacement of the membrane, thereby providing an aerosol droplet formation pattern of improved quality.

The membrane may be formed of any suitable material. By way of example and without limitation, the membrane may be formed of a polymer material, thereby providing advantages of reduced mass and inertia. However, the membrane may be formed of any other suitable material, such as a metallic, semiconductor, dielectric, or ceramic material. The material may be crystalline or amorphous. The membrane may be a composite of two or more different materials. By way of example and without limitation, examples of membrane materials include stainless steel, palladium, silver, alloys such as Ni—Co or Ni—Pd, polyimide and polyamide, silicon, silicon carbide, silicon nitride, aluminium nitride, silicon oxide, ceramics based on aluminium oxide or barium titanate, or combinations thereof such as layered membranes composed of layers of silicon and silicon nitride or silicon oxide or metal. The choice of material(s) used for the membrane may be influenced by the particular liquid aerosol-forming substrate(s) intended to be used with and aerosolised by the aerosolisation module. For example, it is desirable to choose a material for the membrane which does not chemically react with or degrade as a consequence of contact with the chosen liquid aerosol-forming substrate. By way of example only, the membrane may be formed of any of palladium, stainless steel, copper-nickel alloy, polyimide, polyamide, silicon or aluminium nitride.

Preferably the hardness of the sealing member may lie within a range of 5 Shore A to 120 Shore A. More preferably, the hardness of the sealing member may lie within a range of 20 Shore A to 40 Shore A.

As used herein, the reference to “Shore A” is to the Shore A hardness scale. The Shore A hardness value of a sample of material is determined by the extent of penetration of a foot of a durometer into the sample.

Preferably the Young's modulus of the sealing member may lie within a range of 0.001 GPa to 1 GPa. More preferably the Young's modulus of the sealing member may lie within a range of 0.01 GPa to 0.1 GPa.

By way of example, the sealing member may be formed from materials such as neoprene rubber, natural rubber, silicone rubber, nitrile rubber, ethylene propylene diene monomer (EPDM) rubber, styrene-butadiene rubber; silicone rubber is preferred due to its biocompatibility. The hardness and Young's modulus may also be influenced by any processing steps undertaken on the material used for sealing member; for example, the addition of one or more additives to the material selected for the sealing member.

Preferably the axial thickness of the sealing member may lie within a range of 1 millimetre to 10 millimetres. More preferably the axial thickness of the sealing member may lie within a range of 2 millimetres to 5 millimetres.

Preferably, the Young's modulus of the substantially rigid casing lies within a range of 0.1 GPa to 100 GPa, or preferably within a range of 1 GPa to 10 GPa.

Advantageously the membrane may comprise an aerosol-generation zone, the aerosol-generation zone provided with a plurality of nozzles for the passage there-through of liquid aerosol-forming substrate. The plurality of nozzles may allow a dispersion of aerosol droplets to be ejected from the nozzles when a liquid aerosol-forming substrate is fed to one surface of the vibrating membrane. The plurality of nozzles may have a diameter in a range of 1 micrometre to 20 micrometres. As used herein, the term “nozzle” is used to refer to an aperture, hole or bore through the membrane that provides a passage for liquid aerosol-forming substrate to move through the membrane. By way of example and without limitation, during use of the aerosolisation assembly a liquid aerosol-forming substrate may be brought into contact with a first side of the membrane. Vibration of the membrane induced by the vibratory output of the transducer may result in the liquid substrate being urged through the nozzles to be emitted as an aerosol droplet formation pattern from a second (opposing) side of the membrane. The nozzles may be individually sized and arranged relative to each other so as to provide a predetermined aerosol droplet formation pattern.

The coupling of the casing to the sealing member may comprise the casing clamping opposing axial surfaces of the sealing member over at least part of the retention region. Clamping the sealing member may provide a more secure and reliable coupling between the casing and sealing member. Ensuring that the clamping occurs over the retention region of the sealing member—being located outward of the outermost periphery of the aerosolization module—reduces any damping of the vibratory output of the transducer caused by the sealing member being clamped.

The casing may define a bore circumferentially surrounding the sealing member. An interference fit may be defined between corresponding surfaces of the bore of the casing and the sealing member such that the casing radially compresses the sealing member. The interference fit between the corresponding surfaces defines all or part of the retention region. The use of such an interference fit radially compresses the sealing member in contrast to the axial compression of the sealing member resulting from clamping opposing axial surfaces of the sealing member. The use of an interference fit may also be combined with the clamping of opposing axial surfaces of the sealing member.

Advantageously the casing and the sealing member may be substantially axisymmetric. The use of an axisymmetric configuration for the casing and sealing member may allow the constraining effect of the casing on the sealing member to be generally uniform circumferentially around the sealing member. An axisymmetric design may also provide a more uniform aerosol droplet formation pattern from the membrane at different circumferential locations about the membrane.

Advantageously the retention region is substantially annular. The provision of an annular retention region may allow a uniform circumferential constraint to be applied by the casing to the sealing member. The retention region may comprise a group of circumferentially arranged sub-regions collectively defining an annular profile. Circumferentially adjacent ones of the group of sub-regions may be circumferentially spaced apart from each other. By way of example, the casing may clamp opposing axial surfaces of the sealing member by use of pairs of opposed 15 teeth or lugs circumferentially spaced apart from each other around the sealing member. Alternatively, the retention region may comprise a continuous annulus.

Where the retention region is substantially annular, preferably a ratio of an innermost diameter of the annular retention region to an outermost diameter of the aerosolisation module is greater than 1.5. This diameter ratio may provide a sufficient radial gap between the retention region and the outermost periphery of the aerosolisation module to reduce the damping effect of the casing on the vibratory output of the transducer, thereby increasing the proportion of energy supplied to the transducer which is converted into a vibratory displacement of the transducer and thereby of the membrane.

Preferably, the membrane is circular in plan. The use of a circular membrane would be consistent with either or both of the following conditions (a) and (b):
a) the casing and the sealing member being substantially axisymmetric; and
b) the retention region being substantially annular.

A circular membrane may provide for a more uniform aerosol droplet formation pattern from the membrane at different circumferential locations about the membrane. A circular membrane may also be beneficial when the aerosolisation assembly forms part of an elongated cylindrical aerosol-generating device intended to be used as a smoking device.

The vibratable transducer may be encapsulated within the sealing member. Encapsulation of the transducer within the sealing member may protect the transducer from direct exposure to liquid aerosol-forming substrate supplied for use with the aerosolisation assembly, as well as providing some degree of protection from impact damage.

Preferably the vibratable transducer may comprise one or more piezo-electric actuators. Piezo-electric actuators are preferred because they are an energy-efficient and light-weight means of providing a vibratory output from an electric input. Piezo-electric actuators possess a high energy conversion efficiency from electric to mechanical power. Further, piezo-electric actuators are available in a wide variety of materials and shapes. For a piezo-electric actuator, inputting an electrical driving signal to the piezo-electric actuator results in a mechanical output in the form of a vibration. The vibratory output from the transducer induces vibration of the membrane. So, the use of a piezo-electric actuator in or as the transducer provides an energy-efficient means of inducing vibration of the membrane. However, as an alternative to the use of piezo-electric actuators, actuator(s) including one or more of electromagnetic elements, magnetostrictive elements, or electrostrictive elements may also be employed in the vibratable transducer.

The one or more piezo-electric actuators may be arranged to define an annular piezo-electric actuator assembly. In one example, the annular piezo-electric actuator assembly may be formed of a single annular piezo-electric actuator. Alternatively, in another example, the annular piezo-electric actuator assembly may be formed of a plurality of circumferentially arranged piezo-electric actuators collectively defining an annular profile.

In a second aspect of the present disclosure, there is provided an aerosol-generating device comprising a housing, a power source, control electronics, and a vibratory aerosolisation assembly according to any of the variants of the present disclosure. The housing contains the power source and the control electronics. The control electronics are configured to control a supply of power from the power source to the aerosolisation module of the vibratory aerosolisation assembly so as to, in use, activate the vibratable transducer. The housing is configured to retain a reservoir of liquid aerosol-forming substrate in fluid communication with the membrane of the aerosolisation module.

The casing and the housing may be integrally formed as a single piece. Alternatively, the casing may be structurally distinct from the housing.

The control electronics may include one or more controller modules and/or processors configured for use in generating an input driving signal for the vibratable transducer, as well as any computer-readable medium storing instructions for use in the generating of the input driving signal. The computer-readable medium may contain instructions for use in the generating of the input driving signal by the controller modules and/or processors. The computer-readable medium may preferably be a non-transitory computer-readable medium.

Preferably, the power source is rechargeable. By way of example, the power source may comprise a lithium ion battery.

The housing may be sized and shaped to enable the housing to be hand-held by a user. Preferably, the housing is an elongate housing. The elongate housing may be cylindrical in cross-section. The use of an elongate housing corresponds to the geometric profile associated with conventional cigarettes.

The aerosol-generating device may further comprise a cartridge. The cartridge may comprise the reservoir of liquid aerosol-forming substrate. The cartridge may be detachably receivable by the housing of the aerosol-generating device. The cartridge may be disposable whereas the aerosol-generating device may be reusable.

In a third aspect of the present disclosure, there is provided a method of fabricating a vibratory aerosolisation assembly. The method comprises providing an aerosolisation module comprising a vibratable transducer and a membrane. The vibratable transducer is operably coupled to the membrane so as to, in use, vibrate the membrane in a substantially axial direction. The method further comprises sealably coupling a substantially flexible annular sealing member to a peripheral sealing region of the aerosolisation module. The method further comprises coupling a substantially rigid casing to the sealing member. The coupling of the casing to the sealing member is confined to a retention region of the sealing member. The retention region is located outward of an outermost periphery of the aerosolisation module. The casing is more rigid than the sealing member. At least one parameter of the sealing member may be configured so as to militate against damping a vibratory output of the vibratable transducer during use, the at least one parameter comprising one or more of: a hardness of the sealing member; a Young's modulus of the sealing member; and an axial thickness of the sealing member.

The features of the aerosolisation assembly may be as described above and in the remainder of the present disclosure.

Preferably, the hardness of the sealing member may lie within a range of 5 Shore A to 120 Shore A. More preferably, the hardness of the sealing member may lie within a range of 20 Shore A to 40 Shore A.

Preferably, the Young's modulus of the sealing member may lie within a range of 0.001 GPa to 1 GPa. More preferably, the Young's modulus of the sealing member may lie within a range of 0.01 GPa to 0.1 GPa.

Preferably, the axial thickness of the sealing member may lie within a range of 1 millimetre to 10 millimetres. More preferably, the axial thickness of the sealing member may lie within a range of 2 millimetres to 5 millimetres.

Preferably, the Young's modulus of the substantially rigid casing lies within a range of 0.1 GPa to 100 GPa, or preferably within a range of 1 GPa to 10 GPa.

The membrane may comprise an aerosol-generation zone, the aerosol-generation zone provided with a plurality of nozzles for the passage there-through of liquid aerosol-forming substrate.

The plurality of nozzles may have a diameter in a range of 1 micrometre to 20 micrometres.

Advantageously, coupling the casing to the sealing member may comprise clamping opposing axial surfaces of the sealing member with the casing over at least part of the retention region.

The casing may define a bore circumferentially surrounding the sealing member. Further, coupling the casing to the sealing member may comprise defining an interference fit between corresponding surfaces of the bore of the casing and the sealing member such that the casing radially compresses the sealing member. The interference fit between the corresponding surfaces may define all or part of the retention region.

Preferably, the casing and the sealing member may be substantially axisymmetric.

Preferably, the retention region may be substantially annular. The retention region may further comprise a group of circumferentially arranged sub-regions collectively defining an annular profile. Circumferentially adjacent ones of the group of sub-regions may be circumferentially spaced apart from each other. Alternatively, the retention region may comprise a continuous annulus.

Preferably, a ratio of an innermost diameter of the annular retention region to an outermost diameter of the aerosolisation module is greater than 1.5.

The membrane may be circular in plan.

Advantageously, sealably coupling the sealing member to the peripheral sealing region of the aerosolisation module may comprise locating a peripheral edge of the aerosolisation module within an annular recess defined in the sealing member.

Alternatively, sealably coupling the sealing member to the peripheral sealing region of the aerosolisation module may comprise overmolding a peripheral edge of the aerosolisation module to form the sealing member.

The liquid aerosol-forming substrate employed may take many different forms. The following paragraphs describe various exemplary but non-limiting materials and compositions for the liquid aerosol-forming substrate.

The liquid aerosol-forming substrate may comprise nicotine. The nicotine-containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise at least one aerosol-former. An aerosol-former is any suitable known compound or mixture of compounds that, in use, facilitates formation of a dense and stable aerosol. Suitable aerosol-formers are well known in the art and include, but are not limited to: polyhydric alcohols, such as triethylene glycol, 1,3-butanediol and glycerine; esters of polyhydric alcohols, such as glycerol mono-, di-, or triacetate; and aliphatic esters of mono-, di-, or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The liquid aerosol-forming substrate may comprise other additives and ingredients, such as flavourants.

The liquid aerosol-forming substrate may comprise water.

The liquid aerosol-forming substrate may comprise nicotine and at least one aerosol former. The aerosol former may comprise glycerine. The aerosol-former may comprise propylene glycol. The aerosol former may comprise both glycerine and propylene glycol. The liquid aerosol-forming substrate may have a nicotine concentration of between about 2% and about 10%.

The invention is defined in the claims. However, below there is provided a non-exhaustive list of non-limiting examples. Any one or more of the features of these examples may be combined with any one or more features of another example, embodiment, or aspect described herein.

Example Ex1: A vibratory aerosolisation assembly for use in an aerosol-generating device, the vibratory aerosolisation assembly comprising: an aerosolisation module comprising a vibratable transducer and a membrane, in which the vibratable transducer is operably coupled to the membrane so as to, in use, vibrate the membrane in a substantially axial direction; a substantially flexible annular sealing member, the sealing member sealably coupled to a peripheral sealing region of the aerosolisation module; a substantially rigid casing coupled to the sealing member, the coupling of the casing to the sealing member confined to a retention region of the sealing member, the retention region located outward of an outermost periphery of the aerosolisation module; wherein the casing is more rigid than the sealing member; in which at least one parameter of the sealing member is configured so as to militate against damping a vibratory output of the vibratable transducer during use, the at least one parameter comprising one or more of: a hardness of the sealing member; a Young's modulus of the sealing member, and an axial thickness of the sealing member.

Example Ex2: A vibratory aerosolisation assembly according to Ex1, in which the hardness of the sealing member lies within a range of 5 Shore A to 120 Shore A, or preferably within a range of 20 Shore A to 40 Shore A.

Example Ex3: A vibratory aerosolisation assembly according to either one of Ex1 or Ex2, in which the Young's modulus of the sealing member lies within a range of 0.001 GPa to 1 GPa, or preferably within a range of 0.01 GPa to 0.1 GPa.

Example Ex4: A vibratory aerosolisation assembly according to any one of Ex1 to Ex3, in which the axial thickness of the sealing member lies within a range of 1 millimetre to 10 millimetres, or preferably within a range of 2 millimetres to 5 millimetres.

Example Ex4a: A vibratory aerosolisation assembly according to any one of Ex1 to Ex4, in which the Young's modulus of the substantially rigid casing lies within a range of 0.1 GPa to 100 GPa, or preferably within a range of 1 GPa to 10 GPa.

Example Ex5: A vibratory aerosolisation assembly according to any one of Ex1 to Ex4a, the membrane comprising an aerosol-generation zone, the aerosol-generation zone provided with a plurality of nozzles for the passage there-through of liquid aerosol-forming substrate.

Example Ex6: A vibratory aerosolisation assembly according to Ex5, in which the plurality of nozzles have a diameter in a range of 1 micrometre to 20 micrometres.

Example Ex7: A vibratory aerosolisation assembly according to any one of Ex1 to Ex6, in which the coupling of the casing to the sealing member comprises the casing clamping opposing axial surfaces of the sealing member over at least part of the retention region.

Example Ex8: A vibratory aerosolisation assembly according to any one of Ex1 to Ex7, in which the casing defines a bore circumferentially surrounding the sealing member, in which an interference fit is defined between corresponding surfaces of the bore of the casing and the sealing member such that the casing radially compresses the sealing member, wherein the interference fit between the corresponding surfaces defines all or part of the retention region.

Example Ex9: A vibratory aerosolisation assembly according to any one of Ex1 to Ex8, in which the casing and the sealing member are substantially axisymmetric.

Example Ex10: A vibratory aerosolisation assembly according to any one of Ex1 to Ex9, in which the retention region is substantially annular.

Example Ex11: A vibratory aerosolisation assembly according to Ex10, in which the retention region comprises a group of circumferentially arranged sub-regions collectively defining an annular profile.

Example Ex12: A vibratory aerosolisation assembly according to Ex11, in which circumferentially adjacent ones of the group of sub-regions are circumferentially spaced apart from each other.

Example Ex13: A vibratory aerosolisation assembly according to either one of Ex10 or Ex11, in which the retention region comprises a continuous annulus.

Example Ex14: A vibratory aerosolisation assembly according to any one of Ex10 to Ex13, in which a ratio of an innermost diameter of the annular retention region to an outermost diameter of the aerosolisation module is greater than 1.5.

Example Ex15: A vibratory aerosolisation assembly according to any one of Ex1 to Ex14, in which the membrane is circular in plan.

Example Ex16: A vibratory aerosolisation assembly according to any one of Ex1 to Ex15, in which the vibratable transducer is encapsulated within the sealing member.

Example Ex17: A vibratory aerosolisation assembly according to any one of Ex1 to Ex16, in which the vibratable transducer comprises one or more piezo-electric actuators.

Example Ex18: A vibratory aerosolisation assembly according to Ex17, in which the one or more piezo-electric actuators define an annular piezo-electric actuator assembly.

Example Ex19: A vibratory aerosolisation assembly according to Ex18, in which the annular piezo-electric actuator assembly is formed of a single annular piezo-electric actuator.

Example Ex20: A vibratory aerosolisation assembly according to Ex18, in which the annular piezo-electric actuator assembly is formed of a plurality of circumferentially arranged piezo-electric actuators collectively defining an annular profile.

Example Ex21: An aerosol-generating device comprising: a housing; a power source; control electronics; and a vibratory aerosolisation assembly according to any one of Ex1 to Ex20; the housing containing the power source and the control electronics; the control electronics configured to control a supply of power from the power source to the aerosolisation module of the vibratory aerosolisation assembly so as to, in use, activate the vibratable transducer; the housing configured to retain a reservoir of liquid aerosol-forming substrate in fluid communication with the membrane of the aerosolisation module.

Example Ex22: An aerosol-generating device according to Ex21, in which the casing and the housing are integrally formed as a single piece.

Example Ex23: An aerosol-generating device according to Ex21, in which the casing is structurally distinct from the housing.

Example Ex24: An aerosol-generating device according to any one of Ex21 to Ex23, further comprising a cartridge, the cartridge comprising the reservoir of liquid aerosol-forming substrate, the cartridge detachably receivable by the housing of the aerosol-generating device.

Example Ex25: A method of fabricating a vibratory aerosolisation assembly, the method comprising: providing an aerosolisation module comprising a vibratable transducer and a membrane, in which the vibratable transducer is operably coupled to the membrane so as to, in use, vibrate the membrane in a substantially axial direction; sealably coupling a substantially flexible annular sealing member to a peripheral sealing region of the aerosolisation module; coupling a substantially rigid casing to the sealing member, in which the coupling of the casing to the sealing member is confined to a retention region of the sealing member, the retention region located outward of an outermost periphery of the aerosolisation module; wherein the casing is more rigid than the sealing member; in which at least one parameter of the sealing member is configured so as to militate against damping a vibratory output of the vibratable transducer during use, the at least one parameter comprising one or more of: a hardness of the sealing member; a Young's modulus of the sealing member; and an axial thickness of the sealing member.

Example Ex26: A method according to Ex25, in which the hardness of the sealing member lies within a range of 5 Shore A to 120 Shore A, or preferably within a range of 20 Shore A to 40 Shore A.

Example Ex27: A method according to either one of Ex25 or Ex26, in which the Young's modulus of the sealing member lies within a range of 0.001 GPa to 1 GPa, or preferably within a range of 0.01 GPa to 0.1 GPa.

Example Ex28: A method according to any one of Ex25 to Ex27, in which the axial thickness of the sealing member lies within a range of 1 millimetre to 10 millimetres, or preferably within a range of 2 millimetres to 5 millimetres.

Example Ex28a: A method according to any one of Ex25 to Ex28, in which the Young's modulus of the substantially rigid casing lies within a range of 0.1 GPa to 100 GPa, or preferably within a range of 1 GPa to 10 GPa.

Example Ex29: A method according to any one of Ex25 to Ex28a, the membrane comprising an aerosol-generation zone, the aerosol-generation zone provided with a plurality of nozzles for the passage there-through of liquid aerosol-forming substrate.

Example Ex30: A method according to Ex29, in which the plurality of nozzles have a diameter in a range of 1 micrometre to 20 micrometres.

Example Ex31: A method according to any one of Ex25 to Ex30, in which coupling the casing to the sealing member comprises clamping opposing axial surfaces of the sealing member with the casing over at least part of the retention region.

Example Ex32: A method according to any one of Ex25 to Ex31, in which the casing defines a bore circumferentially surrounding the sealing member; in which coupling the casing to the sealing member comprises defining an interference fit between corresponding surfaces of the bore of the casing and the sealing member such that the casing radially compresses the sealing member, wherein the interference fit between the corresponding surfaces defines all or part of the retention region.

Example Ex33: A method according to any one of Ex25 to Ex32, in which the casing and the sealing member are substantially axisymmetric.

Example Ex34: A method according to any one of Ex25 to Ex33, in which the retention region is substantially annular.

Example Ex35: A method according to Ex34, in which the retention region comprises a group of circumferentially arranged sub-regions collectively defining an annular profile.

Example Ex36: A method according to Ex35, in which circumferentially adjacent ones of the group of sub-regions are circumferentially spaced apart from each other.

Example Ex37: A method according to either one of Ex34 or Ex35, in which the retention region comprises a continuous annulus.

Example Ex38: A method according to any one of Ex34 to Ex37, in which a ratio of an innermost diameter of the annular retention region to an outermost diameter of the aerosolisation module is greater than 1.5.

Example Ex39: A method according to any one of Ex25 to Ex38, in which the membrane is circular in plan.

Example Ex40: A method according to any one of Ex25 to Ex39, in which sealably coupling the sealing member to the peripheral sealing region of the aerosolisation module comprises locating a peripheral edge of the aerosolisation module within an annular recess defined in the sealing member.

Example Ex41: A method according to any one of Ex25 to Ex39, in which sealably coupling the sealing member to the peripheral sealing region of the aerosolisation module comprises overmolding a peripheral edge of the aerosolisation module to form the sealing member.

Examples will now be further described with reference to the figures, in which:

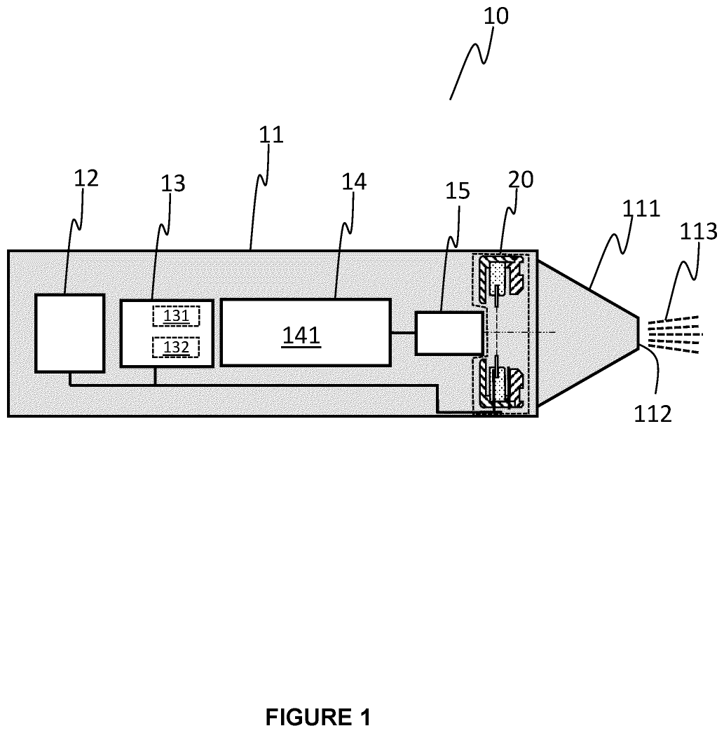

FIG. 1 is a schematic view of a first example of an aerosol-generating device in accordance with the present disclosure.

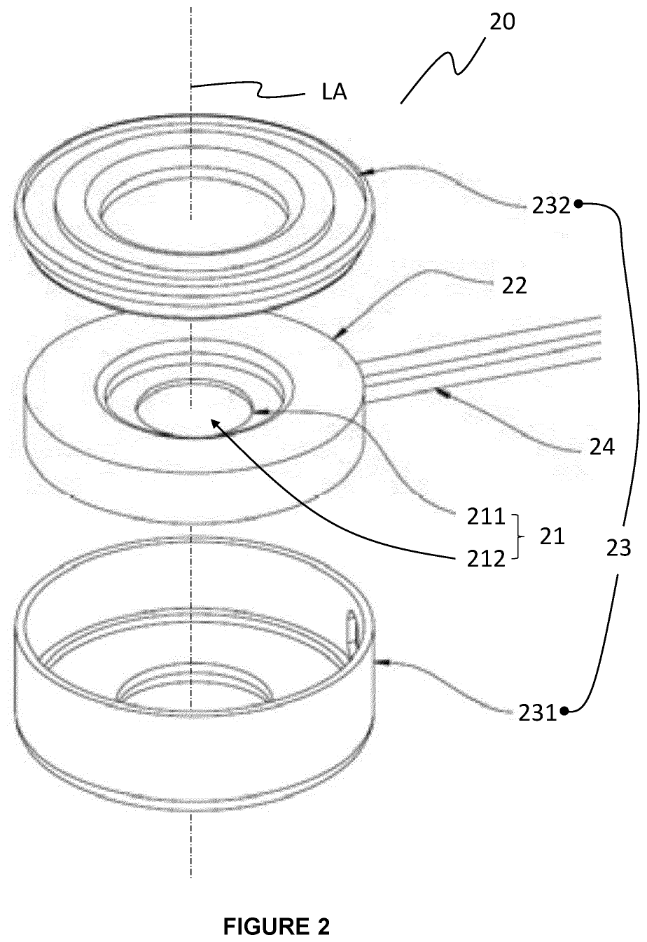

FIG. 2 is a perspective exploded view of the components of a vibratory aerosolisation assembly in accordance with the present disclosure.

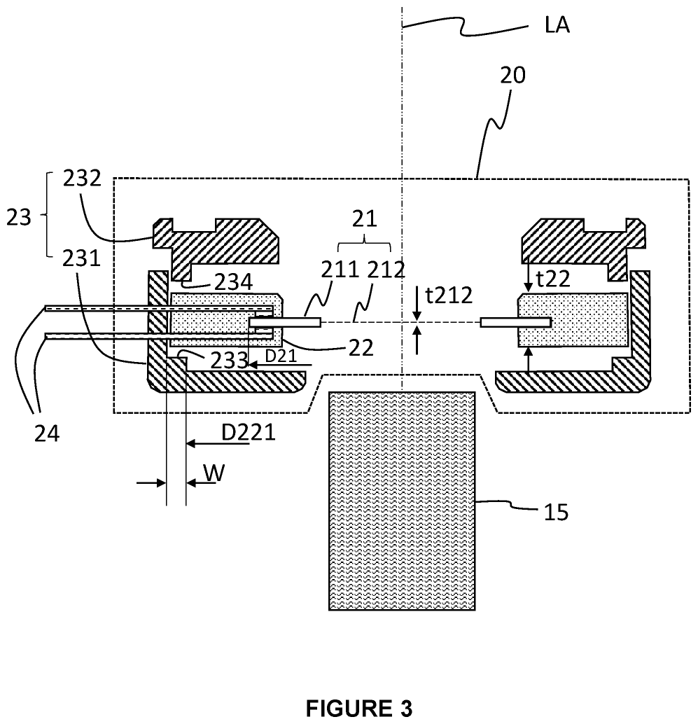

FIG. 3 is a cross-sectional elevation view of the components of the vibratory aerosolisation assembly of FIG. 2 in which the components are shown axially separated from each other.

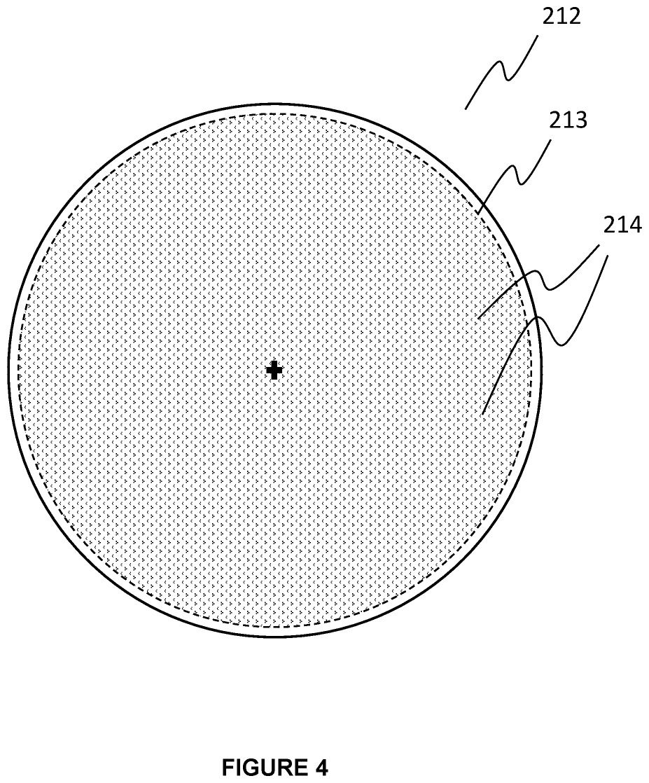

FIG. 4 is a plan view of a membrane of the vibratory aerosolisation assembly of FIGS. 2 and 3.

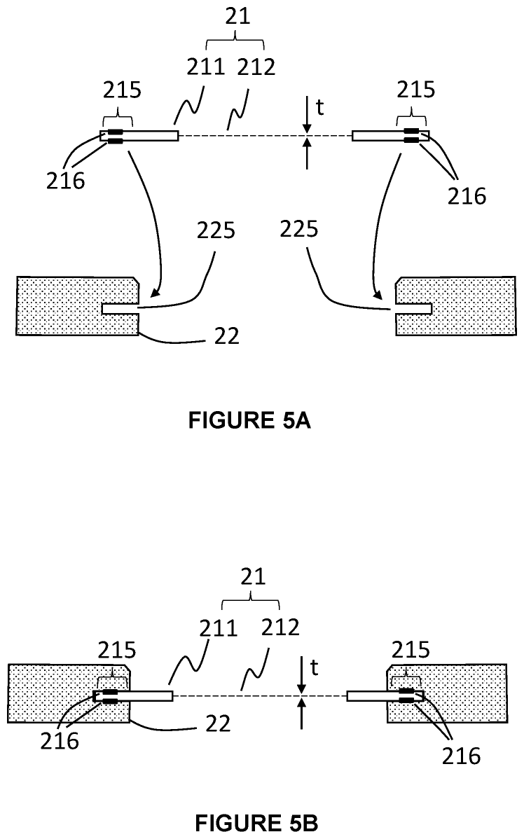

FIGS. 5A and 5B show steps relating to insertion of an annular portion of part of an aerosolisation module into an annular recess of a flexible sealing member.

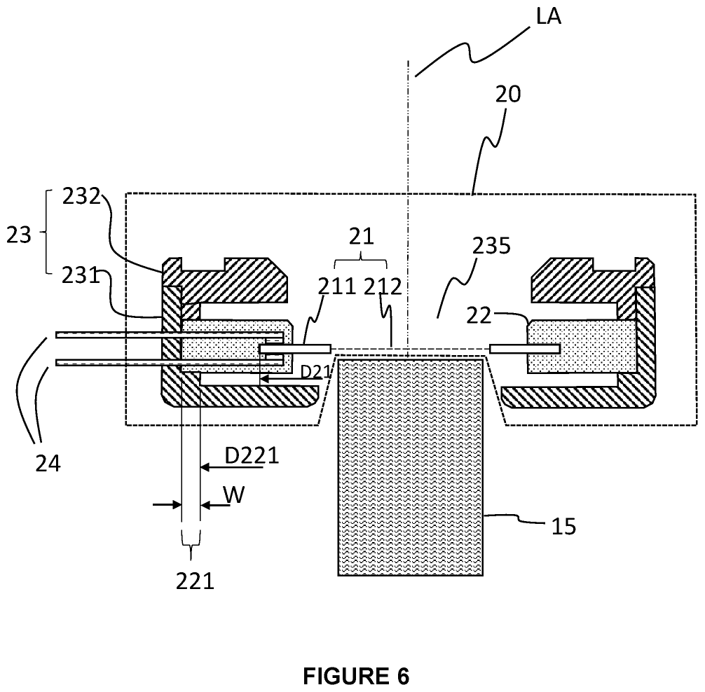

FIG. 6 is a cross-sectional elevation view of the components of the vibratory aerosolisation assembly of FIG. 3, but differing in that the components are shown in a fully assembled condition.

FIG. 1 is a schematic view of a first example of an aerosol-generating device 10. The aerosol-generating device 10 is a smoking device for generating an inhalable aerosol. The aerosol-generating device 10 has an elongate cylindrical housing 11. The housing 11 contains a power source 12, a controller 13, a cartridge 14, a liquid feed assembly 15 and a vibratory aerosolisation assembly 20. The controller 13 controls a supply of power from the power source 12 to the vibratory aerosolisation assembly 20. For the example shown, the power source 12 is a rechargeable lithium ion battery but is not limited thereto. The controller 13 incorporates a processor 131 and a memory module 132. The memory module 132 contains instructions accessible by the processor 131 to enable the controller 13 to control operation of the vibratory aerosolisation assembly 20. The cartridge 14 contains a reservoir 141 of liquid aerosol-forming substrate. The liquid feed assembly 15 is located between the cartridge 14 and the vibratory aerosolisation assembly 20 to feed liquid aerosol-forming substrate from the reservoir 141 to the vibratory aerosolisation assembly. For the example shown, the liquid feed assembly 15 is in the form of a wick of absorbent material; however, in other embodiments, the liquid feed assembly may include a tube extending between the cartridge 14 and the vibratory aerosolisation assembly 20. Although FIG. 1 illustrates an example in which the liquid feed assembly 15 is distinct from the cartridge 14, in other embodiments the liquid feed assembly 15 may be an integral part of the cartridge. A mouthpiece 111 is provided at one end of the housing 11. The mouthpiece 111 includes an opening 112 to allow exit of a dispersal of aerosol droplets 113 ejected from the vibratory aerosolisation assembly 20.

FIGS. 2 and 3 show exploded views of the component parts of the vibratory aerosolisation assembly 20. The vibratory aerosolisation assembly 20 has an aerosolisation module 21, a flexible annular sealing member 22 and a rigid casing 23. The sealing member 22 is formed of a material having a hardness in a range of 5 Shore A to 120 Shore A and a Young's modulus in a range of from 0.001 GPa to 1 GPa. By way of example, the sealing member 22 may be formed from materials such as neoprene rubber, natural rubber, silicone rubber, nitrile rubber, ethylene propylene diene monomer (EPDM) rubber, styrene-butadiene rubber; silicone rubber is preferred due to its biocompatibility. For the illustrated embodiment, the sealing member 22 has an axial thickness t22 of 10 millimetres; however, in other embodiments the axial thickness of the sealing member 22 may be lie anywhere within a range of 1 millimetres to 10 millimetres. The rigid casing 23 is a two-part casing, comprising first part 231 and second part 232. The rigid casing 23 is formed of a material having a Young's modulus in a range of from 0.1 GPa to 100 GPa. However, the material selected for the rigid casing 23 will be one having a Young's modulus greater than that of the flexible sealing member 22, to ensure that the casing is stiffer than the sealing member. By way of example, the rigid casing may be formed from materials such as rigid plastic material (such as but not limited to polypropylene, high-density polyethylene (HDPE), polyethylene terephthalate (PET), polyetheretherketone (PEEK), or polysulfone (PSU)) or a metallic material (such as but not limited to aluminium). For the embodiment illustrated in the figures, the vibratory aerosolisation assembly 20 is a separate component to the housing 11, and is held in position within the housing by any suitable retention means. In this manner, the vibratory aerosolisation assembly 20 may be detached from the housing 11 of the device 10, and/or be reinserted or replaced. However, in an alternative embodiment, the rigid casing 23 may be formed integrally with the housing 11 of the aerosol-generating device 10.

The aerosolisation module 21 includes a vibratable piezo-electric transducer 211 and a membrane 212. As shown in FIG. 4, the membrane 212 is circular when viewed in plan, i.e., along longitudinal axis LA of the vibratory aerosolisation assembly 20. The piezo-electric transducer 211 is annular and coupled to a periphery of the membrane 212. For the illustrated embodiment, a single annular transducer 211 is used. However, in alternative embodiments (not shown in the figures), a plurality of piezo-electric transducers may be circumferentially arranged to collectively define an annular transducer assembly.

As shown in FIG. 4, the membrane 212 has an aerosol generation zone 213. A plurality of nozzles 214 are provided across the aerosol generation zone 213 of the membrane 212. The plurality of nozzles 214 extend through the thickness, t212, of the membrane 212 and have a diameter in a range of between 1 micrometres and 20 micrometres. The diameter of the nozzles 214 may be uniform across all of the nozzles in the aerosol generation zone 213, or may be variable over a range (such as the range of 1 micrometres and 20 micrometres referred to above). The membrane 212 may be formed from polymer, metallic, semiconductor, dielectric, or ceramic materials. The material may be crystalline or amorphous. The membrane may be a composite of two or more different materials. By way of example and without limitation, examples of membrane materials include stainless steel, palladium, silver, alloys such as Ni—Co or Ni—Pd, polyimide and polyamide, silicon, silicon carbide, silicon nitride, aluminium nitride, silicon oxide, ceramics based on aluminium oxide or barium titanate, or combinations thereof such as layered membranes composed of layers of silicon and silicon nitride or silicon oxide or metal.

The piezo-electric transducer 211 is partly encapsulated within the flexible annular sealing member 22. The aerosolisation module 21 (of which the piezo-electric transducer 211 forms part) has an outermost diameter ‘D21’ (see FIG. 3). A pair of electrical wires 24 are coupled to opposing axial surfaces of the transducer 211. The wires 24 pass within the interior of the housing 11 and couple to the controller 13.

In one example of fabricating the vibratory aerosolisation assembly 20, the sealing member 22 is initially provided in the form of a ring provided with an annular recess 225 extending around a radial inner surface of the ring (see FIG. 5A). A peripheral region 215 of the transducer 211 is then positioned within the recess 225 so that the transducer 211 is partly encapsulated within the sealing member 22 (see FIG. 5B). The encapsulation of the peripheral region 215 of the transducer 211 by the sealing member 22 forms a liquid tight seal between the sealing member 22 and transducer 211. The peripheral region 215 of the transducer 211 incorporates electrical contacts 216 for coupling with the electrical wires 24. So, during use of the aerosol-generating device 10, encapsulation of the peripheral region 215 of the transducer 211 within the recess 225 of the sealing member 22 inhibits contact between the liquid aerosol-forming substrate supplied from the cartridge 14 and the electrical contacts 216. The flexible nature of the material used for the sealing member 22 facilitates elastically deforming the sealing member to enable the peripheral region 215 of the transducer 211 to be seated within the annular recess 225. In an alternative example of fabricating the vibratory aerosolisation assembly 20, the flexible sealing member 22 may instead be formed by overmolding the peripheral region 215 of the transducer 211 with sealing member material. In a further alternative embodiment, substantially all of the transducer 211 may be encapsulated by the sealing member 22, leaving only the membrane 212 exposed. However, reducing the radial width of the transducer 211 which is encapsulated within the sealing member 22 will reduce vibrational damping of the vibratory output of the transducer by the sealing member material during use.

As discussed above, the rigid casing 23 is a two-part casing, having a first part 231 and a second part 232—see FIGS. 3 and 6). The first and second parts 231, 232 are both annular. The second part 232 is profiled to be seated inside the first part 231. The first part 231 includes an annular seat 233 and the second part 232 includes an annular protrusion 234. The seat 233 and protrusion 234 are of equal radial width ‘W’. During assembly of the vibratory aerosolisation assembly 20, the sealing member 22 is positioned between the first and second parts 231, 232. The first and second parts 231, 232 are then moved towards each other until the sealing member 22 is clamped between seat 233 and protrusion 234 about annular retention region 221—as shown in FIG. 6. The annular retention region 221 of the sealing member 22 has an innermost diameter D221 and a radial width, the radial width corresponding to the radial width ‘W’ of the seat 233 and protrusion 234. The rigid casing 23 defines a central opening 235 which is slightly greater than the diameter of the membrane 212. As shown in FIG. 6, the casing 23 engages with the sealing member 22 some distance radially outward of the aerosolisation module 21. For the illustrated embodiment, the ratio of the innermost diameter D221 of the retention region 221 of the sealing member 22 to the outermost diameter D21 of the aerosolisation module 21 is greater than 1.5:1.

The figures show an embodiment in which the seat 233 and protrusion 234 are in the form of corresponding annular planar surfaces. However, in an alternative embodiment (not shown) the seat 233 and protrusion 234 may instead be formed as corresponding teeth, thereby reducing the contact area between the rigid casing 23 and the sealing member 22.

In use, the controller 13 controls the supply of power from the power source 12 to the vibratory aerosolisation assembly 20 in accordance with instructions stored in memory module 132. More specifically, the controller 13 sends electrical driving signals to the piezo-electric transducer 211 via the electrical wires 24 coupled to electrical contacts 216. In response to the electrical driving signals, the transducer 211 resonates at a predetermined frequency corresponding to the first resonance mode (also known as the fundamental mode). The value of this frequency will vary dependent on the nature of the piezo-electric transducer 211 that is used;

in one example, the first resonance mode of the transducer 211 is around 140 kHz. Vibration of the transducer 211 in turn induces vibration of the membrane 212. Liquid aerosol-forming substrate is fed from the reservoir 141 of cartridge 14 via liquid feed assembly 15 to one side of the vibrating membrane 212. The vibrating action of the membrane 212 causes liquid aerosol-forming substrate to be ejected through the nozzles 214 of the membrane 212 as a dispersion of aerosol droplets 113 (see FIG. 1). The dispersion of aerosol droplets 113 exits the interior of the housing 11 of the aerosol-generating device 10 via the opening 112 of mouthpiece 111. The use of a resonance mode of around 140 kHz in combination with various of the other features described above has been found to result in reduced damping of the vibratory output of the transducer 211.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A vibratory aerosolisation assembly for an aerosol-generating device, the vibratory aerosolisation assembly comprising:
an aerosolisation module comprising a vibratable transducer and a membrane, in which the vibratable transducer is operably coupled to the membrane so as to vibrate the membrane in a substantially axial direction;
a substantially flexible annular sealing member sealably coupled to a peripheral sealing region of the aerosolisation module; and
a substantially rigid casing coupled to the substantially flexible annular sealing member, the coupling of the substantially rigid casing to the substantially flexible annular sealing member being confined to a retention region of the substantially flexible annular sealing member, the retention region being located outward of an outermost periphery of the aerosolisation module,
wherein the substantially rigid casing is more rigid than the substantially flexible annular sealing member,
wherein at least one parameter of the substantially flexible annular sealing member is configured so as to militate against damping a vibratory output of the vibratable transducer during use, the at least one parameter comprising one or more of:
a hardness of the substantially flexible annular sealing member,
a Young's modulus of the substantially flexible annular sealing member, and
an axial thickness of the substantially flexible annular sealing member,
wherein the substantially rigid casing defines a bore circumferentially surrounding the substantially flexible annular sealing member,
wherein an interference fit is defined between corresponding surfaces of the bore of the substantially rigid casing and the substantially flexible annular sealing member such that the substantially rigid casing radially compresses the substantially flexible annular sealing member, and
wherein the interference fit between the corresponding surfaces defines all or part of the retention region.

17. The vibratory aerosolisation assembly according to claim 16, wherein the membrane comprises an aerosol-generation zone, the aerosol-generation zone being provided with a plurality of nozzles configured for passage therethrough of liquid aerosol-forming substrate.

18. The vibratory aerosolisation assembly according to claim 16, wherein the coupling of the substantially rigid casing to the substantially flexible annular sealing member comprises the substantially rigid casing clamping opposing axial surfaces of the substantially flexible annular sealing member over at least part of the retention region.

19. The vibratory aerosolisation assembly according to claim 16, wherein the substantially rigid casing and the substantially flexible annular sealing member are substantially axisymmetric.

20. The vibratory aerosolisation assembly according to claim 16, wherein the retention region is substantially annular.

21. The vibratory aerosolisation assembly according to claim 20,
wherein the retention region comprises a group of circumferentially arranged sub-regions collectively defining an annular profile, and
wherein circumferentially adjacent ones of the group of sub-regions are circumferentially spaced apart from each other.

22. The vibratory aerosolisation assembly according to claim 20, wherein the retention region comprises a continuous annulus.

23. The vibratory aerosolisation assembly according to claim 16, wherein the membrane is circular in plan.

24. The vibratory aerosolisation assembly according to claim 16, wherein the vibratable transducer is encapsulated within the substantially flexible annular sealing member.

25. The vibratory aerosolisation assembly according to claim 16, wherein the vibratable transducer comprises one or more piezoelectric actuators.

26. An aerosol-generating device, comprising:
a housing;
a power source;
control electronics; and
a vibratory aerosolisation assembly according to claim 16,
wherein the housing contains the power source and the control electronics,
wherein the control electronics are configured to control a supply of power from the power source to the aerosolisation module of the vibratory aerosolisation assembly so as to activate the vibratable transducer, and
wherein the housing is configured to retain a reservoir of liquid aerosol-forming substrate in fluid communication with the membrane of the aerosolisation module.

27. The aerosol-generating device according to claim 26, wherein the substantially rigid casing and the housing are integrally formed as a single piece.

28. The aerosol-generating device according to claim 26, wherein the substantially rigid casing is structurally distinct from the housing.

29. A method of fabricating a vibratory aerosolisation assembly, the method comprising:
providing an aerosolisation module comprising a vibratable transducer and a membrane, in which the vibratable transducer is operably coupled to the membrane so as to vibrate the membrane in a substantially axial direction;
sealably coupling a substantially flexible annular sealing member to a peripheral sealing region of the aerosolisation module; and
coupling a substantially rigid casing to the substantially flexible annular sealing member, in which the coupling of the substantially rigid casing to the substantially flexible annular sealing member is confined to a retention region of the substantially flexible annular sealing member, the retention region being located outward of an outermost periphery of the aerosolisation module,
wherein the substantially rigid casing is more rigid than the substantially flexible annular sealing member,
wherein at least one parameter of the substantially flexible annular sealing member is configured so as to militate against damping a vibratory output of the vibratable transducer during use, the at least one parameter comprising one or more of:
a hardness of the substantially flexible annular sealing member,
a Young's modulus of the substantially flexible annular sealing member, and
an axial thickness of the substantially flexible annular sealing member,
wherein the substantially rigid casing defines a bore circumferentially surrounding the substantially flexible annular sealing member,
wherein coupling the substantially rigid casing to the substantially flexible annular sealing member comprises defining an interference fit between corresponding surfaces of the bore of the substantially rigid casing and the substantially flexible annular sealing member such that the substantially rigid casing radially compresses the substantially flexible annular sealing member, and
wherein the interference fit between the corresponding surfaces defines all or part of the retention region.
